(19) United States
(12) Patent Application Publication
(10) Pub. No.: US 2007/0083424 A1
(43) Pub. Date: Apr. 12, 2007

(54) Portal for secure validation of parking and integrated services

(76) Inventors: Darin R. Lang, Burien, WA (US); John P. Martin, Renton, WA (US); Jack E. Nichols, Seatac, WA (US); Vaughn D. Harmon, Seattle, WA (US)

Correspondence Address: DARBY & DARBY P.C., P. O. BOX 5257, NEW YORK, NY, 10150-5257, US

(21) Appl. No.: 11/246,356

(22) Filed: Oct. 7, 2005

(51) Int. Cl. G07B 15/00

(52) U.S. Cl. 705/13

(57) ABSTRACT

An interface to a parking application, such as a web portal, is provided over a secure network connection to tenants for managing parking validation services as well as related parking services and other integrated building services. An authenticated user may provide information for authorizing full, partial, or subsidized payment for a use of a parking facility, such as a use by a guest. The information may be provided by way of a personal computer, a mobile device, a special-purpose terminal, or the like. If the guest then presents a ticket at a separate attended or unattended exit terminal or point-of-sale device to complete the parking transaction, the transaction is processed in accordance with the provided information. According to other aspects of the invention, techniques for enabling configurable event notifications for events associated with validation services, and techniques for associating parking events with video and/or photographic image data are provided.

### FIELD OF THE INVENTION

The present invention relates generally to computer systems for managing building services, and more particularly, but not exclusively, to employing networked devices to manage parking validation and other services for a building.

### BACKGROUND OF THE INVENTION

In commercial, residential, or mixed-use buildings that have parking facilities, tenants are typically provided with a means for validating the parking of guests so that they need not pay all or part of the charges imposed by the parking facilities. Tenants often purchase, in advance, a set of validation stickers, or similar physical validation means (such as coupons, vouchers, tokens, decals, mechanical ticket punch systems, or stamps), from the management of the parking facility. Usually these validation stickers are sold in books containing some minimum number and are typically nonrefundable. Also, a validation sticker is generally associated with a fixed time increment or cash amount. Typically, minimum and maximum limits are placed on available validation time that are determined by the tenant and/or the parking management.

A guest who parks in a parking facility generally obtains a ticket upon entering the facility. Typically, prior to leaving the tenant's premises, the guest presents the parking ticket to the tenant for validation. When the guest's vehicle exits the parking facility, a cashier applies the cash value of the validation stickers in determining a final transaction charge, if any, for the guest. Similar parking validation procedures are in use in other kinds of properties having parking facilities, such as shopping centers, academic buildings, arts, cultural, and entertainment facilities, and in other settings. In addition, residents of multi-unit residential complexes typically are able to purchase validation coupons for their guests.

The current approach to parking validation has a number of drawbacks. Tenants cannot easily analyze their parking-related costs and track such costs in internal accounting systems. Validation stickers are subject to theft and misappropriation (for example, by tenant employees and by parking facility cashiers). The current approach also may limit the ability of parking facility operators to automate pay parking transactions. The ability of tenants to control parking costs is also limited by the time increment units and rate uniformity associated with the use of validation stickers. More generally, current practices related to payment for parking services in buildings, and the like, provide limited opportunity for tenants and their employees to control and customize pricing and payment.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following detailed description of the invention, which is to be read in association with the accompanying drawings, wherein:

FIG. 1 shows a functional diagram illustrating one embodiment of an environment for practicing the invention;

FIG. 2 illustrates a logical flow diagram generally showing one embodiment of a process for providing interfaces for parking validation-related services and other building services over a network;

FIG. 3 illustrates a logical flow diagram generally showing one embodiment of a process for enabling completion of a parking transaction for use of a parking facility, based on parking validation information provided over a network by way of a parking application, such as a web portal;

FIG. 4 illustrates a logical flow diagram generally showing one embodiment of a process for providing configurable event notifications for events associated with validation services and other parking-related events;

FIG. 5 illustrates a logical flow diagram generally showing one embodiment of a process for associating parking events with video and/or photographic image data;

FIG. 6 illustrates a logical flow diagram generally showing one embodiment of a process for enabling generation of an audit report relating to parking validation and other parking-related services;

FIG. 7 is a diagram that illustrates an organization of data fields associated with a validated parking ticket;

FIG. 8A is a screenshot of a web portal page that provides an interface for validation of a parking ticket;

FIG. 8B is a screenshot of a web portal page that displays information relating to an entered validated ticket; and

FIG. 8C is a screenshot of a web portal page that displays historical data relating to validated tickets.

### DETAILED DESCRIPTION OF THE INVENTION

The present invention will now be described more fully hereinafter with reference to the accompanying drawings, which form a part hereof, and which show, by way of illustration, specific exemplary embodiments by which the invention may be practiced. The invention may, however, be embodied in many different forms, and this specification should not be construed to limit the invention to the embodiments set forth herein. Rather, these embodiments are provided so that this disclosure will be thorough and complete and will convey fully the scope of the invention to those skilled in the art.

The invention is directed towards employing networked computers to provide online tools for managing parking validation services as well as related parking services and other integrated building services. The parking validation services and other parking services relate to the use of a vehicle in a parking facility. Validation of parking transactions may include identifying a user associated with a vehicle, identifying an entity that authorized payment, and/or identifying a tenant visited by a user. A “vehicle” includes, but is not limited to, a motorized vehicle having wheels, such as an automobile, motorcycle, moped, scooter, or Segway® transporter, and also includes non-motorized vehicles, such as bicycles, tricycles and unicycles.

In accordance with the invention, the online tools are made accessible over a network to commercial building tenants, apartment building residents, building property managers, parking operators, and the like. The invention is applicable to various building environments that include or have contractual arrangements with fee-charging parking garages, lots, or other parking facilities. Such environments may include, for example, multi-tenant office buildings, shopping complexes, multi-unit residential buildings, mixed-use commercial/residential complexes, airports, harbors, stadiums, convention centers, houses of worship, industrial buildings, manufacturing buildings, and the like.

An authorized user, such as an authorized employee of a tenant, may operate a networked device, such as a personal computer, a mobile phone or other mobile device, a special-purpose terminal, or another kind of networked device, to communicate with a parking application, such as a portal, a server, or the like, over a secure or authenticated connection. The application makes available, by way of a communicated page, message, or the like, an interface through which the user may provide information for authorizing payment (full, partial, or subsidized) for the use of a parking facility by, for example, a guest of the user. If the guest then presents a ticket at an attended or unattended exit terminal, or an attended or unattended point of sale, to complete the parking transaction, the exit terminal, point-of-sale terminal, or another device (for example, a mobile device) is employed to communicate over the network with the application or another device in communication with and/or sharing data with the application.

Embodiments of the invention thus obviate the use of physical validation stickers and like mechanisms for validation of parking and enable tenants and others to avoid the costs that typically accompany those mechanisms. Moreover, the invention enables property managers, tenants and others to exercise greater control over the pricing of parking services for guests, employees, and others. For example, tenants may specify, over the network, the precise time period for which a guest's parking is validated, the precise amount of the total parking cost to be validated, and a particular rate plan to be applied. In addition, the invention provides reporting functionality that enables tenants, property managers, parking operators, and others to closely and accurately track their parking-related costs online, which may aid in reducing loss and preventing fraud.

In environments in which the invention may be practiced, offices, stores, apartments, and the like may include networked computers or other devices, such as special-purpose terminals, that communicate with a parking application, such as a portal server or the like, over a network. Moreover, in embodiments of the invention, the parking application may be accessed by way of a secure or authenticated connection over a publicly-accessible network, and the parking application may be accessed by a user even if the user is not currently at the premises of the office, store, apartment, or the like. Parking facilities may have manned entry and/or exit points, or they may have entry and/or exit points that are partly or fully automated. Moreover, parking facilities may have manned or unmanned point-of-sale terminals that are separate from entry/exit terminals. In each case, a device is employed to communicate with the parking application over a network. For example, an exit station of a parking facility handling a transaction may have an attendant operating a networked computer terminal, or it may have an unattended or an unattended networked exit terminal that can read magnetic stripe cards and the like.

Additionally, embodiments of the invention enable building tenants to manage building-related services, including parking-related services as well as other services. For example, an employee with a permit for an associated parking facility may interact with a web portal interface, displayed by way of a personal computer, a special-purpose terminal, a web-enabled mobile device, or the like, to manage payment for the account associated with the permit. As another example, an office building tenant may use online tools available by way of a portal to control elevator access to the tenant's premises, to make maintenance requests, to activate after-hours climate control for the premises, and so forth.

Embodiments of the invention also enable a user to configure event-triggered notifications and alerts associated with validation services and other parking-related services. The event notification system is a general one that may be configured in various ways by tenants, property managers, and other authorized users. A user may configure the category of event as well the notification method to be employed. Event triggers may be based on user-defined thresholds, programmable rules, and so forth. As one example, an alert might be sent when a particular access card is used to enter a parking facility. As another example, when validations for a tenant exceed a given threshold, a notification system may be configured to send an alert to a tenant office manager. Notification mechanisms may be of various kinds, including e-mail, SMS messages, pager alerts, instant messages, and the like.

According to another aspect of the present invention, parking events may be associated with video and photographic image data. One or more video cameras, still cameras, CCTV cameras, and the like may be deployed in a parking facility to photographically record video or still images. For example, a parking facility may have several surveillance cameras monitoring entry and exit points, permitting recording of activities in the parking facility from multiple camera angles, each providing a different view of an event. In some cases recording may be triggered by the occurrence of a parking event, such as a gate entry or exit. Video, still photos captured from video frames, and still camera images may be recorded by appropriate devices. In accordance with the invention, video cameras and/or still cameras are coupled to one or more computing devices that associate recorded video or image data with a time marker and an event type. For a given event, multiple channels of video or photographic data may thus be associated with the same event type and time marker. Recorded data is stored by way of a database or the like. Search or querying of the database over the network, such as by way of a portal or another application provided in accordance with the invention, is enabled. Embodiments of the invention thus enable camera-based recordings of events of interest, including multiple-source recordings for a given event, to be retrieved relatively easily, rather than requiring a user to manually forward through a substantial length of recorded video. The technique might be employed, for example, by a parking operator to determine an entry time for a customer who claims to have lost a ticket.

Illustrative Operating Environment

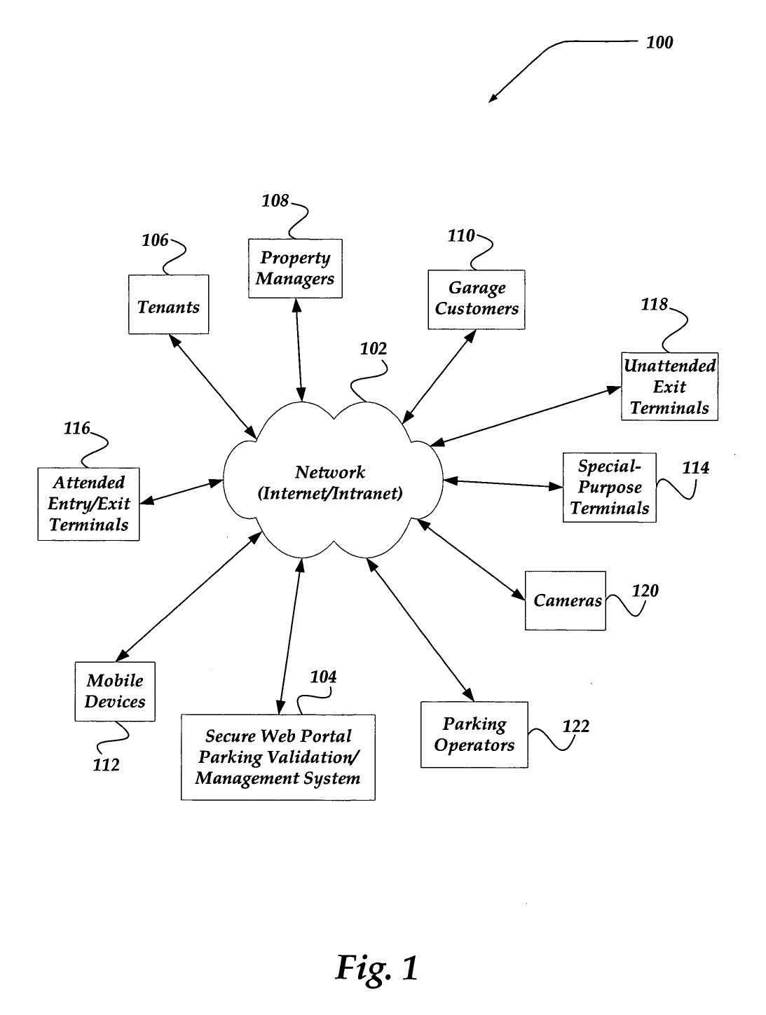

FIG. 1 provides a simplified view of one embodiment of an environment within which the present invention may operate. Not all of the depicted components may be required to practice the invention, however, and some embodiments of the invention may include additional components not shown in the figure. Variations in the arrangement and type of the components may be made without departing from the spirit or scope of the invention.

As illustrated in FIG. 1, environment 100 includes secure web portal 104 for a parking validation/management system. In communication with web portal 104 over network 102 are devices operated by various classes of users, including tenants 106, garage customers 110, property managers 108, and parking operators 122. These devices include devices of various kinds capable of wired and/or wireless communication with web portal 104, such as personal computers, mobile phones, personal digital assistants, and other mobile devices 112, and special-purpose terminals 114. Mobile devices 112 may be web-enabled mobile devices.

In commercial settings, tenants 106 may specifically include personnel at each of tenants 106 authorized to access web portal 104 to provide information relating to parking validation for guests, parking accounts for employees, and other parking-related or building-related services. In residential settings, tenants 106 may include residents of a building authorized to access web portal 104. Garage customers 110, such as an employee of one of tenants 106 having a permit to park in a building parking facility but not having authorization to validate parking for guests or others, may also be in communication with web portal 104 over network 102, for example by way of a networked personal computer or special-purpose terminal 114 on or away from the premises of tenant 106, and/or by way of mobile device 112. Property managers 108 manage the building at which the garage or other parking facility is located. Among the responsibilities of property managers 108 are assigning parking rate plans and assigning parking charges. Parking operators 122 are responsible for the day-to-day operation of parking facilities. Employees of parking operators 122 may man attended entry/exit terminals 116 and perform other parking facility operations.

Also in communication with web portal 104, and/or one or more computing devices (not shown) linked to web portal 104, are devices that may be deployed in a parking facility, including attended entry/exit terminals 116, unattended exit terminals 118, and cameras 120, which may include digitally-recording CCTV cameras, video cameras, still cameras, and the like. In a typical parking garage, multiple cameras may be situated at particular locations in the facility to monitor parkers and employees. Attended entry/exit terminals 116 may include special-purpose terminals 114, a conventional networked personal computer, or other devices. Unattended exit terminals 118 are typically special-purpose devices and may be configured to read credit cards, debit cards, other magnetic stripe data cards, magnetic access cards, and the like. In some cases, attended entry/exit terminals 116 and/or unattended exit terminals 118 may function as point-of-sale devices. Point-of-sale devices, both attended and unattended, may also be special-purpose devices or other devices situated in locations other than at an entry or exit point.

Devices such as terminals operated by tenants 106, garage customers 110, property managers 108, and parking operators 122, attended entry/exit terminals 116, unattended exit terminals 118, cameras 120 (such as CCTV cameras, video cameras, or still cameras), mobile devices 112, special-purpose terminals 114, and web portal 104 each represent computing devices of various kinds. Such devices may generally include any device that is configured to perform computation and that is capable of sending and receiving data communications by way of one or more wired and/or wireless communication interfaces. Such devices may be configured to communicate in accordance with any of a variety of network protocols, including but not limited to protocols within the TCP/IP protocol suite. In particular, devices such as terminals operated by tenants 106, garage customers 110, property managers 108, and parking operators 122, as well as attended entry/exit terminals 116 and other devices that access web portal 104, are generally user-interactive computing devices that typically run browser applications, and the like, to display requested pages received over a network in accordance with a network protocol such as HTTP or HTTPS, WTP for WAP-enabled mobile devices, and the like. For example, devices operated by tenants 106 may include special-purpose terminals 114 that provide a means for validation of parking tickets of users of a parking facility. Web portal 104 may include an HTTP server application and the like, and may include or be linked to other applications, such as a database management system.

Network 102 is configured to couple one computing device to another computing device to enable communication of data between the devices. Network 102 may generally be enabled to employ any form of machine-readable media for communicating information from one device to another. Network 102 may include one or more of a wireless network, a wired network, a local area network (LAN), a wide area network (WAN), a direct connection such as through a Universal Serial Bus (USB) port, and the like, and may include the set of interconnected networks that make up the Internet. On an interconnected set of LANs, including networks employing differing protocols, a router acts as a link between LANs, enabling messages to be sent from one to another. Communication links within LANs typically include twisted wire pair or coaxial cable. Communication links between networks may generally use analog telephone lines, full or fractional dedicated digital lines including T1, T2, T3, and T4, Integrated Services Digital Networks (ISDNs), Digital Subscriber Lines (DSLs), wireless links including satellite links, or other communication links known to those skilled in the art. Remote computers and other network-enabled electronic devices may be remotely connected to LANs or WANs by way of a modem and temporary telephone link. In essence, network 102 may include any communication method by means of which information may travel between computing devices. Communication with web portal 104 over network 102 may include an authenticated, encrypted, or otherwise secured network connection over the public Internet. Network 102 include a virtual private network, a corporate intranet with gateways to the public Internet, an extranet, and the like.

The media used to transmit information across information links as described above illustrate one type of machine-readable media, namely communication media. Generally, machine-readable media include any media that can be accessed by a computing device or other electronic device. Machine readable media may include processor-readable media, data storage media, network communication media, and the like, and may typically embody information that includes processor-readable instructions, data structures, program components, or other data.

Generalized Operation

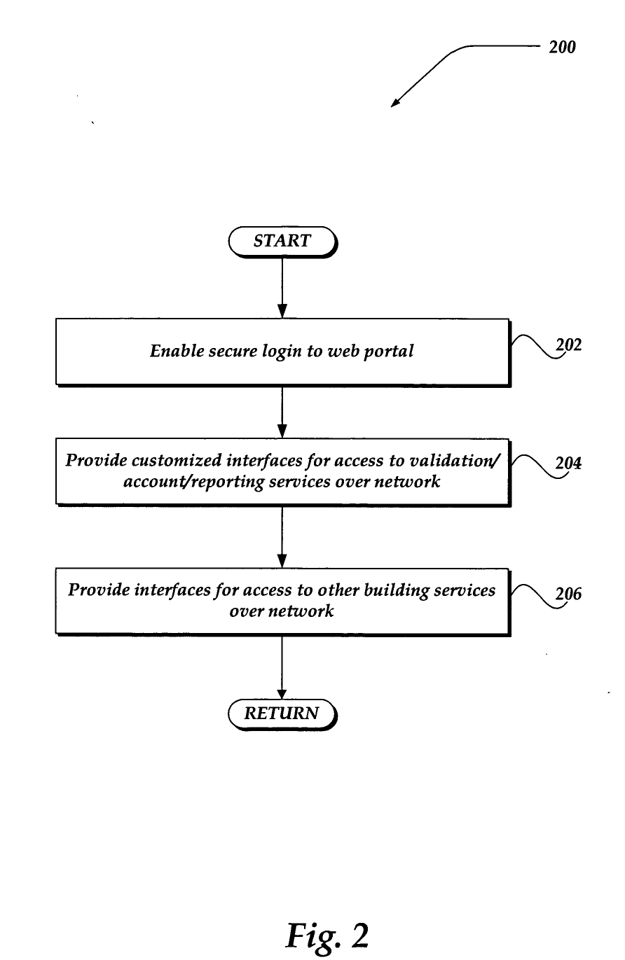

The operation of certain aspects of the invention will now be described with respect to FIGS. 2-6. FIG. 2 illustrates a logical flow diagram generally showing one embodiment of a process for providing interfaces for parking validation-related services and other building services over a network. Process 200 begins, following a start block, at block 202, where a secure network login to a parking application, such as a web portal, is enabled. Processing flows to block 204, at which interfaces are provided by way of the parking application to an authenticated user. The interfaces enable access over the network to online tools for management of parking validation services, parking-related account and reporting services, and other parking-related services. The presentation of the interfaces may be customized to a particular user or tenant, or the like. Process 200 next flows to block 206, where additional interfaces are provided that enable access to management of other integrated building services, such as elevator access control, communications of maintenance requests, after-hours climate and power control, and the like. Processing then returns to a calling process to perform other actions.

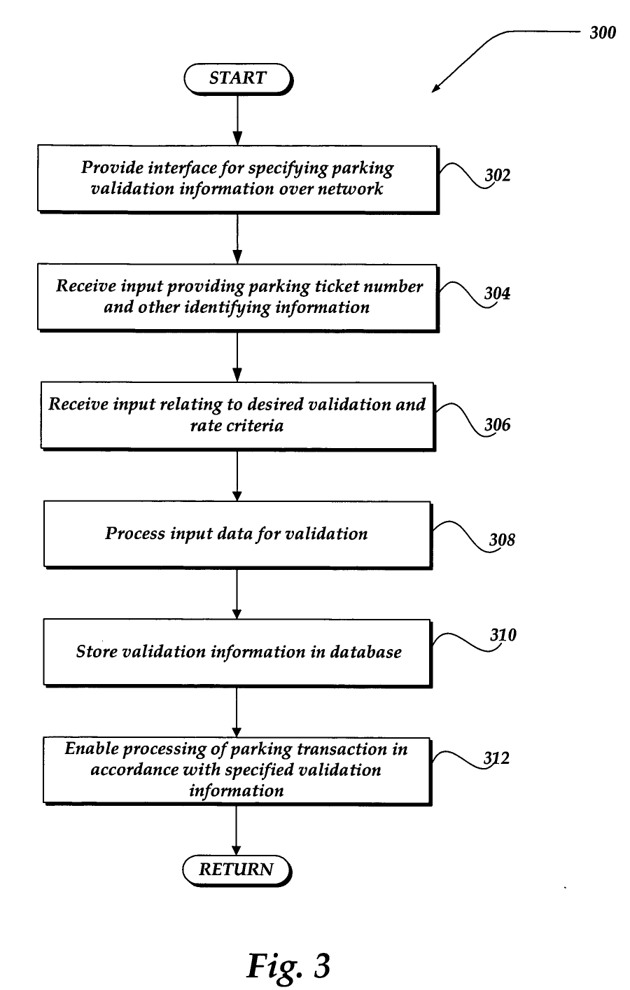

FIG. 3 illustrates a logical flow diagram generally showing one embodiment of a process for enabling completion of a parking transaction for use of a parking facility, based on parking validation information provided over a network by way of a parking application, such as a web portal. Following a start block, process 300 flows to block 302, at which an interface for providing parking validation information is provided over the network to an authorized user, such as an authorized employee of a tenant. Processing then steps to block 304, at which input specifying parking validation information is received, such as a parking ticket number for a guest and other identifying information, such as a confirmation number, a customer or client identification number, or the like. When a ticket number is entered, the system may retrieve and display information associated with the ticket from a database (for example, an arrival time); for a new ticket this may include suggesting default values based on preconfigured options.

Processing continues at block 306, where input is received that further specifies desired parking validation criteria, such as an applicable rate plan, an amount of a total parking cost to be validated or discounted, and so forth. Process 300 next advances to block 308, at which the input data is processed to enable subsequent validation for the guest. Processing then flows to block 310, at which validation information and other input data and generated data are stored persistently in the database. At block 312, a parking transaction for the guest is processed at an attended or unattended exit terminal, an attended or unattended point-of-sale terminal not situated at an exit or egress point, or the like, in accordance with the provided validation information which is retrieved from the database. Process 300 then returns to a calling process to perform other actions.

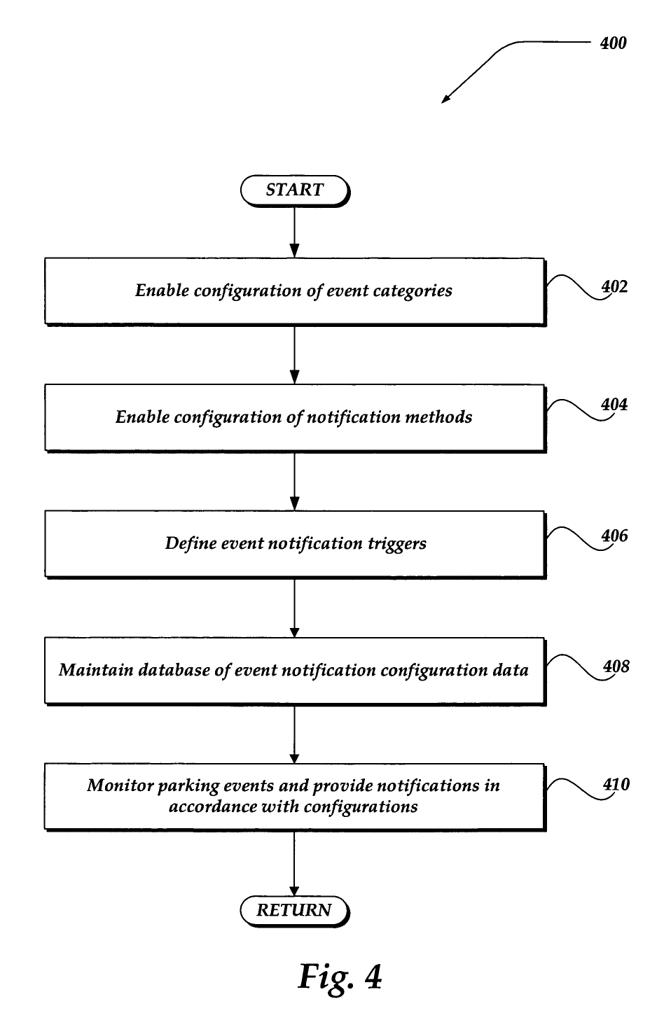

FIG. 4 illustrates a logical flow diagram generally showing one embodiment of a process for providing configurable event notifications for events associated with validation services and other parking-related events. Following a start block, process 400 flows to block 402, at which configuration by a user of event categories for notification is enabled (for example, a user may specify that an alert be sent when a particular access card is used to enter the parking facility). At block 404, configuration of notification methods is enabled. For example, a user may specify that notifications or alerts be sent by way of e-mail, SMS, pager notification, instant message, or the like. Next, at block 406, event notification triggers may be defined; for example, triggers may be based on specified thresholds, rules, or the like. Process 400 then advances to block 408, at which event notification configuration data is maintained in a database. At block 410, parking events are monitored, and event notifications and alerts are provided in accordance with stored configuration data. Process 400 then returns to perform other actions.

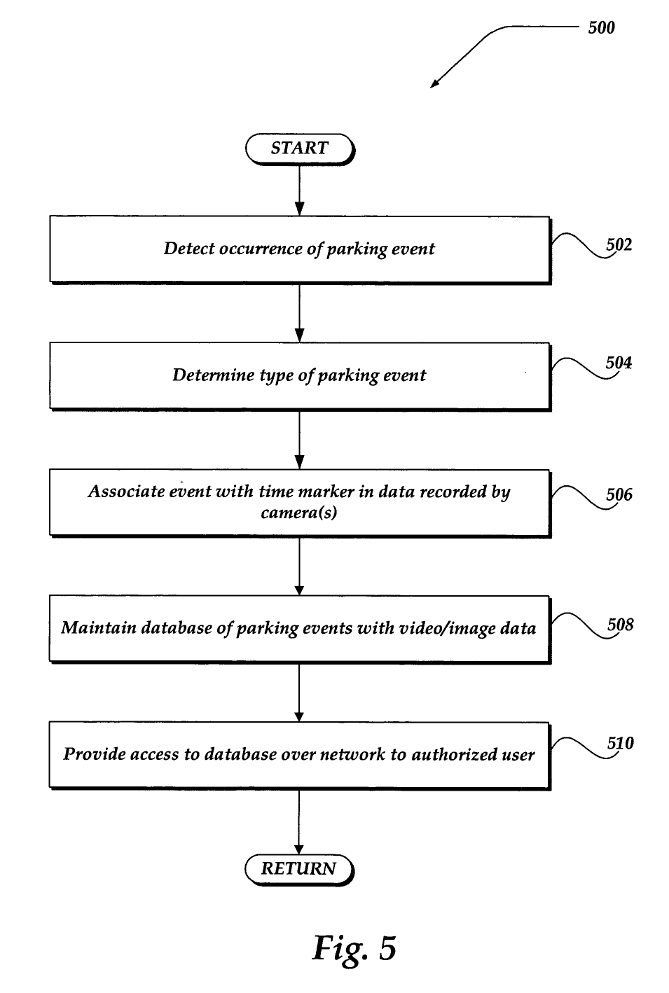

FIG. 5 illustrates a logical flow diagram generally showing one embodiment of a process for associating parking events with video and/or photographic image data obtained by way of video cameras, still photographic cameras, and the like. Process 500 begins, after a start block, at block 502, where the occurrence of one of a set of parking events is detected. Parking events may include, for example, the raising or lowering of an entry or exit gate. Next, process 500 flows to block 504, at which the type of the parking event is determined. Processing then steps to block 506, where the determined event is associated with a time marker in a recording of the event. The recording may include video data, still photos captured from recorded video frames, photos from still cameras, and so forth. Multiple sources or channels of video or photographic data may be recorded for a given event and time marker, as for example in the case of a parking facility in which several cameras record a gate entry at a particular time from different angles. Next, at block 508, a database of parking events is maintained by storing data relating to the determined event and the time marker of the video or image data associated with the event. The database may also store or enable a means of accessing a video clip, still photo, or the like corresponding to the time marker. In other embodiments of the invention, means other than a database may be employed. Process 500 next flows to block 510, at which access is provided to the database over a network to an authorized user. The user may, for example, retrieve one or more video recording clips and/or photographic images of a vehicle entering a parking facility gate at a given time. Process 500 then returns to a calling process to perform other actions.

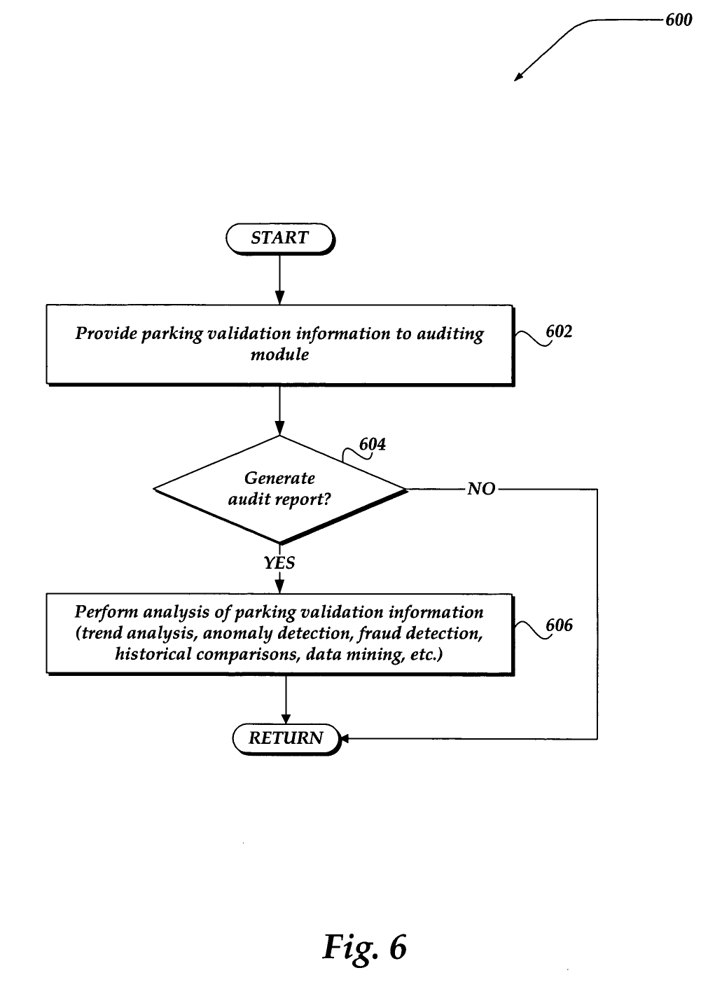

FIG. 6 illustrates a logical flow diagram generally showing one embodiment of a process for enabling generation of an audit report relating to parking validation and other parking-related services. Following a start block, process 600 flows to block 602, where stored parking validation information, such as information relating to processed parking transactions with validated payment, is provided to an auditing module. Process 600 then flows to decision block 604, at which a determination is made whether to generate an audit report. For example, a web portal may provide an interface that enables an authorized user, such as an authorized employee of a tenant, to produce an audit report of parking validation-related transactions. If generating an audit report is not selected or indicated, processing returns to a calling process to perform other actions. If, however, it is determined that an audit report is to be generated, process 600 branches to block 606, at which analysis of the data is performed and compiled into an audit report. Analysis may include, for example, trend analysis, detection of anomalies, detection of patterns suggesting fraud, historical comparisons, data mining, and so forth. Process 600 then returns to a calling process to perform other actions.

Customized Data Fields and Interface

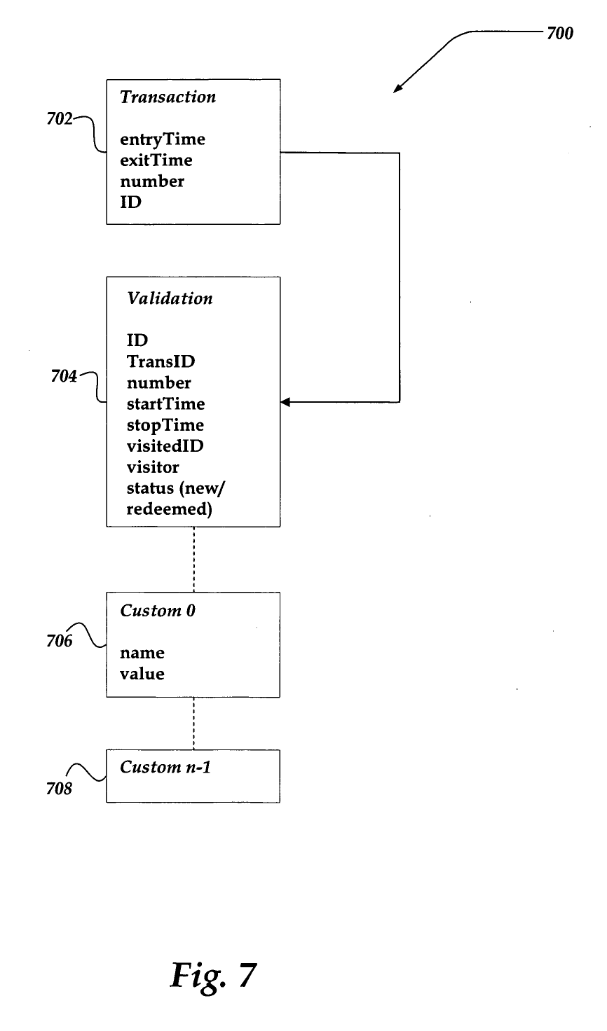

FIG. 7 is a diagram that illustrates an organization of data fields associated with a validated parking ticket for which information is entered by way of a web portal interface. FIG. 7 is presented for illustrative purposes, and those skilled in the art will appreciate that numerous other kinds and orderings of default and customized data fields are possible. An initial set of entered data relating to a parking transaction may be stored in a table or other structure 702 having fields such as an entry time, an exit time, a ticket number, and a generated internal ID which may be employed as a database key. Table 702 may be generated, for example, when a guest of a tenant enters the parking facility and obtains a parking ticket. An employee of a tenant may enter information relating to a guest's parking ticket (for example, when the guest is ready to leave the tenant's premises) by way of the web portal interface. Validation of the parking may then be selected, in which case additional data is entered and stored in a generated validation table 704 that is associated with or linked to table 702. Validation table 704 includes such fields as the database key, a transaction ID, the ticket number, a validation start time and stop time (which may differ from the previously-stored entry and exit times), an identification of the person visited, an identification of the visitor, and a validation ticket status (new or redeemed).

The web portal validation interface provides authorized users, including tenants and property managers, with the opportunity to define one or more custom fields with which to collect data that can be associated with a parking ticket and with a validation transaction. This is illustrated in FIG. 7 in custom data fields 706-708. For example, a tenant may define a custom field for storing a client number or customer number. Defined custom fields 706-708 may be employed to search, sort, and group validation data and other parking-related data.

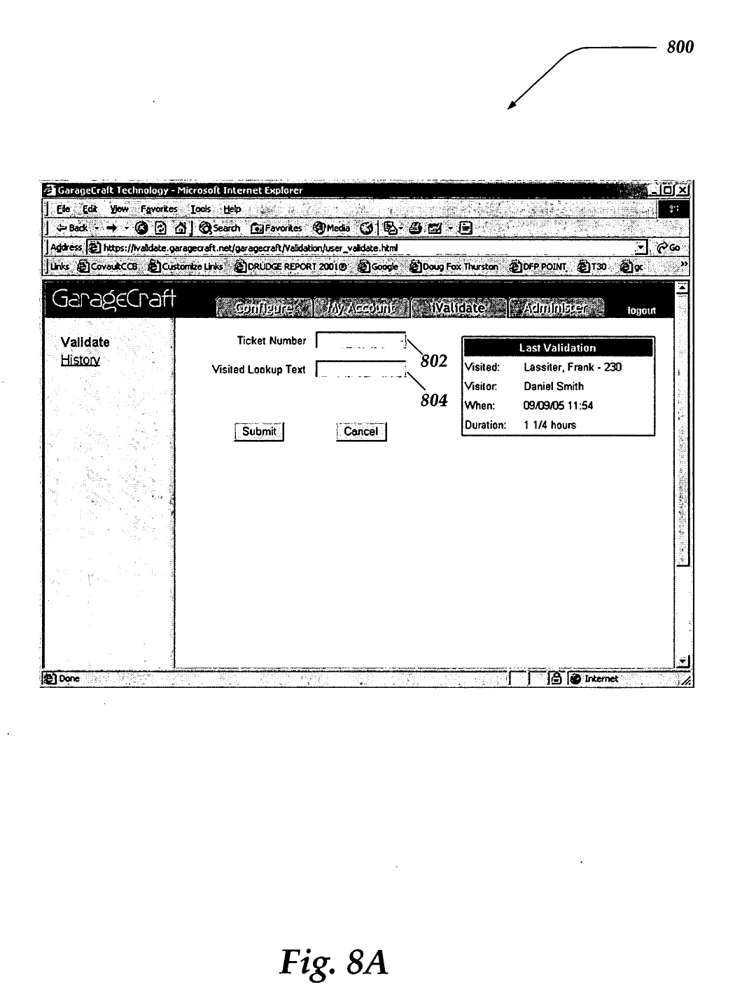

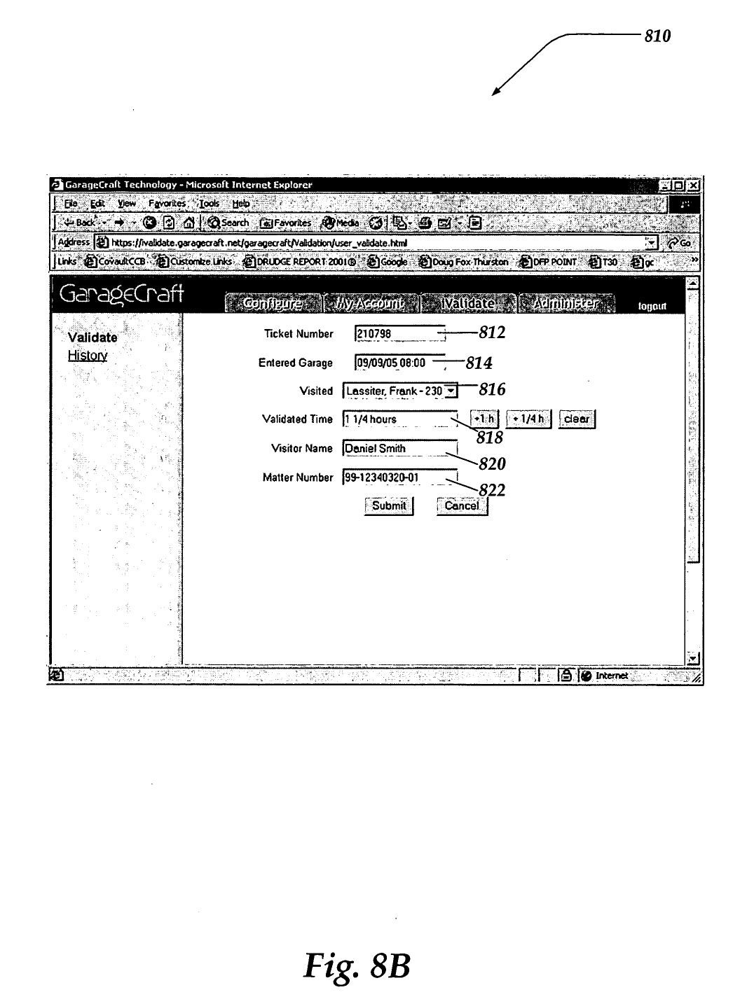

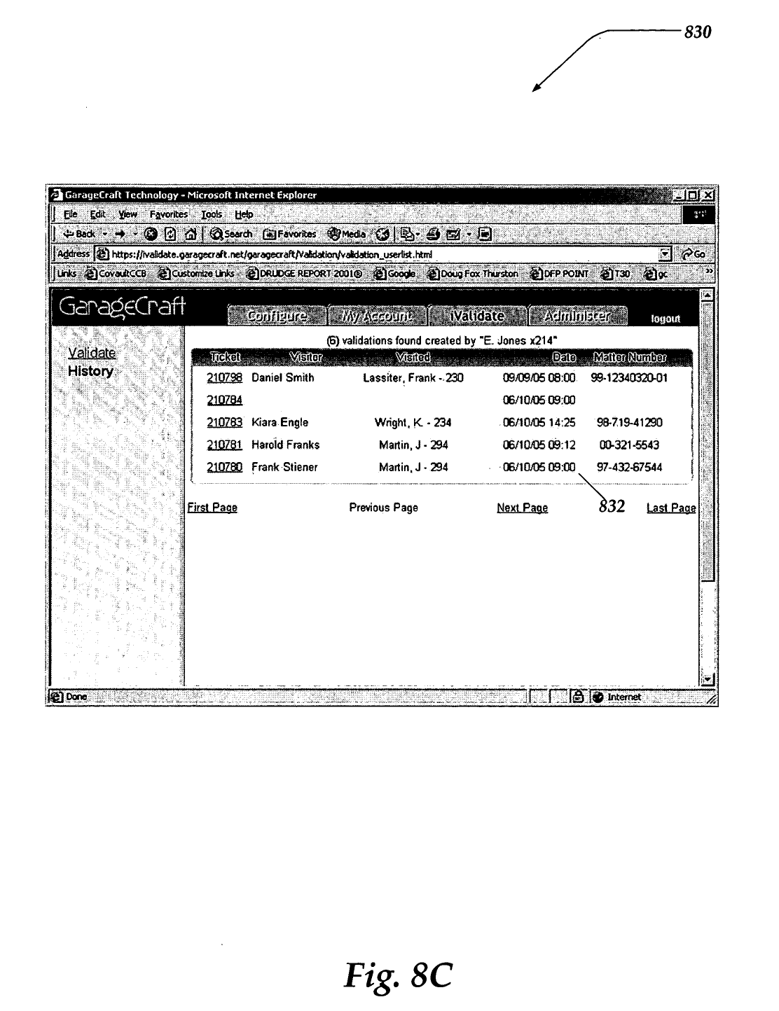

FIGS. 8A, 8B, and 8C are screenshots that illustrate aspects of one embodiment of a parking validation interface in accordance with the invention. It will be appreciated that these screenshots are exemplary only and that in different embodiments of the invention an interface may have various features and characteristics. FIG. 8A is a screenshot of a web portal page that provides an interface for validation of a parking ticket. As shown, the interface includes, among other features, box 802 in which a transaction identification number, such as a parking ticket number, can be entered and box 804 in which text may be entered for a lookup for an identification of a person visited. A transaction identification number may be, for example, a string of characters, including alphanumeric and/or non-alphanumeric characters.

FIG. 8B is a screenshot of a web portal page that may be employed for input of and display of information relating to a parking transaction associated with an entered transaction identification number. For example, the interface shown in screenshot 810 may be displayed after a user has entered and submitted a ticket number by way of the interface shown in screenshot 800. As shown in FIG. 8B, various boxes for display and entry of text may be displayed, such as ticket number 812, garage entry date and time 814, drop-down list of qualified persons 816 that may be assigned as the person visited by the tenant currently being validated, validated time 818, visitor name 820, and matter number 822. Initially, when the page is displayed, the boxes may contain information retrieved from a database, including data already associated with an entered ticket number (for example, an entry time associated with an entered ticket number may already be recorded in the database) and/or default values based on preconfigured options. For ease in entering validated time in box 818, buttons associated with a particular time increment may be selected.

One or more of the displayed boxes may be associated with fields that have been custom-defined by a tenant or property manager. For example, a tenant, such as a law firm, may have used a configuration page to define a matter number field not provided by default. Consequently, as illustrated in FIG. 8B, an associated box 822 for entry of a matter number is then displayed after entry of a ticket number along with other boxes associated with other data fields. Custom-defined fields may be used by tenants or other users to help manage, track, and organize parking validation expenditures and other aspects of parking transactions.

FIG. 8C is a screenshot of a web portal page that displays historical data relating to validated tickets. History page 830 may be displayed upon selection of a link in another page displayed by the web portal. The page may include the display of a table, such as table 832, that presents information retrieved from a database relating to validations created by a particular user. As shown, table 832 includes columns for ticket number, visitor name, person visited, date, and matter number. As in FIG. 8B, matter number may be an example of a custom-defined field.

The above specification provides a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A method for providing a parking service, comprising:
providing access over a network to an interface for providing information for authorizing a payment for a use of a parking facility, wherein the interface is accessible over the network from at least one device that is separate from an exit terminal; and
processing a validated transaction for the use of the parking facility by a vehicle based at least in part on the provided information.

2. The method of claim 1, wherein the interface is provided by way of a personal computer, a mobile device, or a special-purpose terminal.

3. The method of claim 1, wherein the payment for the use of the parking facility includes at least one of a complete payment, a partial payment, or a subsidized payment.

4. The method of claim 1, wherein validation of the transaction includes at least one of (a) identifying a user associated with the vehicle, (b) identifying an entity that authorized payment, or (c) identifying a tenant visited by the user.

5. The method of claim 1, wherein the interface includes at least one page associated with a portal.

6. The method of claim 1, further comprising enabling a definition of at least one field for data associated with the use of the parking facility.

7. The method of claim 1, further comprising, if a transaction identification is provided by way of the interface:
retrieving information relating to a parking transaction associated with the transaction identification; and
displaying the retrieved information by way of the interface.

8. The method of claim 1, further comprising enabling a configuration of an event notification, wherein the event notification is triggered by an event associated with the parking service.

9. The method of claim 8, wherein the event notification includes at least one of an e-mail message, an instant message, an SMS message, or a pager notification.

10. The method of claim 1, wherein the access to the interface is provided by way of a secure login.

11. The method of claim 1, wherein the validated transaction is processed by way of a secure network connection.

12. The method of claim 1, further comprising providing access over the network to an interface for generating a report relating to at least one transaction for use of the parking facility.

13. The method of claim 1, wherein processing the validated transaction is by way of one of an unattended terminal, an attendant-operated terminal, or a point-of-sale device.

14. The method of claim 1, wherein providing access to the interface further comprises enabling payment over the network for a parking account.

15. The method of claim 1, further comprising providing access to at least a portion of a recording of a parking event by at least one camera device, wherein the access is by way of accessing a determined occurrence of the event.

16. The method of claim 1, wherein the interface is provided by way of an application programming interface (API).

17. A server for providing a parking service, comprising:
a network interface;
a memory for storing data and instructions; and
a processor in communication with the memory and the network interface, wherein the processor enables actions based on the stored instructions, including:
providing access over a network to an interface for providing information for authorizing a payment for a use of a parking facility, wherein the interface is accessible over the network from at least one device that is separate from an exit terminal; and
processing a validated transaction for the use of the parking facility by a vehicle based at least in part on the provided information.

18. The server of claim 17, wherein the payment for the use of the parking facility includes at least one of a complete payment, a partial payment, or a subsidized payment.

19. The server of claim 17, wherein the validation of the transaction includes at least one of (a) identifying a user associated with the vehicle, (b) identifying an entity that authorized payment, or (c) identifying a tenant visited by the user.

20. The server of claim 17, wherein the interface includes at least one page associated with a portal.

21. The server of claim 17, further comprising enabling a definition of at least one field for data associated with the use of the parking facility.

22. The server of claim 17, further comprising, if a transaction identification is provided by way of the interface:
retrieving information relating to a parking transaction associated with the transaction identification; and
displaying the retrieved information by way of the interface.

23. The server of claim 17, further comprising enabling a configuration of an event notification, wherein the event notification is triggered by an event associated with the parking service.

24. The server of claim 23, wherein the event notification includes at least one of an e-mail message, an instant message, an SMS message, or a pager notification.

25. The server of claim 17, wherein the access to the interface is provided by way of a secure login.

26. The server of claim 17, further comprising providing access over the network to an interface for generating a report relating to at least one transaction for use of the parking facility.

27. The server of claim 17, wherein providing access to the interface further comprises enabling payment over the network for a parking account.

28. The server of claim 17, further comprising providing access to at least a portion of a recording of a parking event by at least one camera device, wherein the access is by way of accessing a determined occurrence of the event.

29. A client for providing a parking service, comprising:
a network interface;
a memory for storing data and instructions; and
a processor in communication with the memory and the network interface, wherein the processor enables actions based on the stored instructions, including:
accessing an interface over a network, wherein the interface enables information to be provided for authorizing a payment for a use of a parking facility, and wherein the interface is accessed from at least one device that is separate from an exit terminal; and
enabling a processing a validated transaction for the use of the parking facility by a vehicle based at least in part on the provided information.

30. The client of claim 29, wherein the payment for the use of the parking facility includes at least one of a complete payment, a partial payment, or a subsidized payment.

31. The client of claim 29, wherein validation of the transaction includes at least one of (a) identifying a user associated with the vehicle, (b) identifying an entity that authorized payment, or (c) identifying a tenant visited by the user.

32. The client of claim 29, wherein the interface includes at least one page associated with a portal.

33. The client of claim 29, further comprising providing a definition of at least one field for data associated with the use of the parking facility.

34. The client of claim 29, further comprising:
enabling a retrieval of information relating to a parking transaction, wherein the parking transaction is associated with a transaction identification provided by way of the interface; and
enabling a display of the retrieved information by way of the interface.

35. The client of claim 29, further comprising providing a configuration of an event notification, wherein the event notification is triggered by an event associated with the parking service.

36. The client of claim 35, wherein the event notification includes at least one of an e-mail message, an instant message, an SMS message, or a pager notification.

37. The client of claim 29, wherein accessing the interface is by way of a secure login.

38. The client of claim 29, further comprising accessing an interface over the network for generating a report relating to at least one transaction for use of the parking facility.

39. The client of claim 29, wherein accessing the interface further comprises enabling payment over the network for a parking account.

40. The client of claim 29, further comprising accessing at least a portion of a recording of a parking event by at least one camera device, wherein the access is by way of accessing a determined occurrence of the event.

41. An apparatus for providing a parking service, comprising:
a network interface;
a memory for storing data and instructions; and
a processor in communication with the memory and the network interface, wherein the processor enables actions based on the stored instructions, including:
accessing an interface over a network, wherein the interface enables information to be provided for authorizing a payment for a use of a parking facility, and wherein the interface is accessed from at least one device that is separate from an exit terminal; and
enabling a processing a validated transaction for the use of the parking facility by a vehicle based at least in part on the provided information.

42. A processor-readable medium having processor-executable code thereon for enabling actions for providing a parking service, comprising:
providing access over a network to an interface for providing information for authorizing a payment for a use of a parking facility, wherein the interface is accessible over the network from at least one device that is separate from an exit terminal; and
processing a validated transaction for the use of the parking facility by a vehicle based at least in part on the provided information.

43. A processor-readable medium having processor-executable code thereon for enabling actions for providing a parking service, comprising:
accessing an interface over a network, wherein the interface enables information to be provided for authorizing a payment for a use of a parking facility, and wherein the interface is accessed from at least one device that is separate from an exit terminal; and
enabling a processing a validated transaction for the use of the parking facility by a vehicle based at least in part on the provided information.

44. A system for providing a parking service, comprising:
a first device for providing information for authorizing a payment for a use of a parking facility, wherein the first device is separate from an exit terminal; and
a second device in communication with the first device, wherein the second device is for processing a validated transaction for the use of the parking facility by a vehicle based at least in part on the provided information.

45. A method for providing data associated with a use of a parking facility, comprising:
determining an occurrence of a parking event;
enabling at least one recording of the parking event by way of at least one camera device;
associating the at least one recording of the parking event with a time; and
providing access to at least a portion of the recording by way of accessing the occurrence of the parking event.

46. The method of claim 45, wherein the at least one camera device includes at least one of a CCTV camera, a surveillance camera, a video camera, or a still camera.

47. The method of claim 45, wherein the at least one recording includes at least one of a video clip, a video frame, or a still photograph image.

48. The method of claim 45, wherein providing access to at least a portion of the video recording further comprises enabling a search of at least one of a parking event type or a time.

49. The method of claim 45, wherein at least two camera devices are employed to provide a view of the event from a plurality of camera angles.

50. The method of claim 45, wherein the parking event includes at least one of an entry event, an exit event, or a transaction event.

51. The method of claim 45, further comprising employing at least a portion of a parking event to determine a fee for a parking transaction.

52. A processor-readable medium having processor-executable code thereon for performing actions for providing video data associated with a use of a parking facility, comprising:
determining an occurrence of a parking event;
enabling at least one recording of the parking event by way of at least one camera device;
associating the at least one recording of the parking event with a time; and
providing access to at least a portion of the recording by way of accessing the occurrence of the parking event.
